(19) United States
(12) Patent Application Publication
(10) Pub. No.: US 2024/0201421 A1
(43) Pub. Date: Jun. 20, 2024

(54) Anti-Reflection Coating for Blocking Infrared Radiation and Display Device Including the Same

(71) Applicant: Buwon Precision Sciences Co., Ltd., Taoyuan County (TW)

(72) Inventors: Kyeong-Jeun Woo, Taoyuan County (TW); Po-Yao Lai, Taoyuan County (TW)

(21) Appl. No.: 18/539,617

(22) Filed: Dec. 14, 2023

(30) Foreign Application Priority Data
Dec. 14, 2022 (TW) 111148098

(51) Int. Cl. G02B 1/115; G02B 5/20

(52) U.S. Cl. CPC G02B 1/115; G02B 5/208

(57) ABSTRACT

An anti-reflection coating for blocking infrared radiation and a display device including the same are provided. The anti-reflection coating includes an anti-refractive composite layer, an oxidation protective layer and a visible light anti-reflection layer. The oxidation protective layer is disposed on the anti-refractive composite layer, and the visible light anti-reflection layer is disposed on the oxidation protection layer. The anti-reflection coating has a reflectance ranging from 0% to 1% in a wavelength range of 370 to 780 nm, and has a reflectance ranging from 3% to 80% in a wavelength range of 780 to 2500 nm.

### CROSS-REFERENCE TO RELATED APPLICATION

This application claims priority from Taiwan Patent Application No. 111148098, filed on Dec. 14, 2022, in the Taiwan Intellectual Property Office, the content of which is hereby incorporated by reference in its entirety for all purposes.

### BACKGROUND OF THE INVENTION

### 1. Field of the Invention

The present disclosure relates to an anti-reflection coating, and more particularly to an anti-reflection coating and a display device including the same for blocking infrared radiation and enhancing a transmittance of visible light.

### 2. Description of the Related Art

With the advancement of science and technology, various display devices have been developed and become indispensable while providing convenience in people's lives. In addition to personal electronic devices (e.g., mobile phones and smart watches), outdoor display devices capable of presenting dynamic and colorful visual effects for people, are growing, such as outdoor billboards and electronic bus stops.

However, the traditional display may produce strong reflection under the sun since the ambient light is brighter than the display. To clearly see the content of the display, the user must maximize the brightness of the display, which consumes power and causes overheating to the display device. Such an issue becomes more severe for outdoor display devices. The heat from the irradiated radiations of the sun and generated by the display operating at high brightness usually overheats the display device to reach a temperature about 80 degrees, causing short circuits and dealing damages to the outdoor display devices. In addition, the infrared radiations of the sunlight also penetrate into the outdoor display device, which also causes damages to internal components, accelerates the aging of the components, and reducing the service life of the display device.

Therefore, an improved anti-reflection coating against the above deficiencies is developed in the present disclosure to promote industrial implementation and utilization in the art.

### SUMMARY OF THE INVENTION

In response to the above-referenced technical inadequacies, the present disclosure provides an anti-reflection coating for blocking infrared radiation, and the anti-reflection coating includes: an anti-refractive composite layer; an oxidation protective layer disposed on the anti-refractive composite layer; and a visible light anti-reflection layer disposed on the oxidation protection layer; in which the anti-reflection coating has a reflectance ranging from 0% to 1% in a wavelength range of 370 to 780 nm, and has a reflectance from 3% to 80% in a wavelength range of 780 to 2500 nm.

Preferably, the anti-reflection coating has a transmittance ranging from 90% to 100% in the wavelength range of 370 to 780 nm.

Preferably, the anti-reflection coating has a reflectance ranging from 3% to 80% and a transmittance ranging from 0% to 60% in a wavelength range of 780 nm to 2500 nm.

Preferably, the visible light anti-reflection layer includes silicon dioxide.

Preferably, the anti-reflection composite layer includes a first anti-reflection composite layer and/or at least one second anti-reflection composite layer, and the at least one second anti-reflection composite layer is disposed on a surface of the first anti-reflection composite layer.

Preferably, a thickness ratio of the oxidation protective layer, the anti-reflection composite layer and the visible light anti-reflection layer is 30.07 to 31.93:T: 43.65 to 46.35, T=A+n×B, A is a thickness of the first anti-reflection composite layer, B is a thickness of the second anti-reflection composite layer, and n is an integer.

Preferably, the first anti-reflection composite layer includes, sequentially from top to bottom, a first aluminum-doped zinc oxide layer, a metal layer, a second aluminum-doped zinc oxide layer and a niobium pentoxide layer in a thickness ratio of 4.85 to 5.15:10.67 to 11.33:4.85 to 5.15:19.4 to 20.6.

Preferably, each of the at least one second anti-reflection composite layer includes, sequentially from top to bottom, a first aluminum-doped zinc oxide layer, a metal layer, a second aluminum-doped zinc oxide layer zinc layer and a niobium pentoxide layer in a thickness ratio is 4.85 to 5.15:10.67 to 11.33:4.85 to 5.15:56.26 to 59.74.

In another aspect, the present disclosure provides a display device, which includes: a substrate; and a first anti-reflection coating being the anti-reflection coating described above, and the first anti-reflection coating is disposed on a surface of the substrate.

Preferably, the display device further includes a second anti-reflection coating being the anti-reflection coating described above, and the second anti-reflection coating is disposed on another surface of the substrate.

Therefore, in the anti-reflection coating for blocking infrared radiation provided by the present disclosure, the oxidation protective layer, the anti-refractive composite layer and the visible light anti-reflection layer are laminated with specific refractive indices and thicknesses to achieve a required optical refraction, in which a transmittance increases and a reflectance decreases in a wavelength range of visible light, while a transmittance decreases and a reflectance increases in a wavelength range of infrared light. Furthermore, in the anti-reflection coating for blocking infrared radiation provided by the present disclosure, an intensity of visible light emitted by the display screen and color rendering index (CRI) are increased, thereby reducing the brightness required under strong sunlight, the power consumption and the heat generated. Moreover, the anti-reflection coating for blocking infrared radiation provided by the present disclosure blocks the infrared radiations from penetrating into the display screen and reflects 32-48% of heat radiation from sunlight, thereby avoiding internal components being damaged by infrared radiations, reducing the heat absorption caused by sunlight, increasing the service life and reducing the use cost.

### BRIEF DESCRIPTION OF THE DRAWINGS

The features and technical contents of the present disclosure will be further appreciated and understood with reference to the detailed description of preferred embodiments and accompanying drawings.

FIG. 1 is a schematic diagram of an anti-reflection coating for blocking infrared radiation according to a first embodiment of the present disclosure.

FIG. 2 is a schematic diagram of an anti-reflection coating for blocking infrared radiation according to a second embodiment of the present disclosure.

FIG. 3 is a schematic diagram of an anti-reflection coating for blocking infrared radiation according to a third embodiment of the present disclosure.

FIG. 4 is a schematic diagram of an anti-reflection coating for blocking infrared rays according to a fourth embodiment of the present disclosure.

FIG. 5 is a schematic diagram of a display device applying the anti-reflection coatings of FIGS. 1 to 4 according to a fifth embodiment of the present disclosure.

FIG. 6 is a schematic diagram of a display device applying the anti-reflection coatings of FIGS. 1 to 4 according to a sixth embodiment of the present disclosure.

FIG. 7 is a graph showing a comparison made between reflectance of the anti-reflection coating for blocking infrared radiation of the present disclosure at different wavelengths.

FIG. 8 is a graph showing a comparison made between reflectance of the anti-reflection coating for blocking infrared radiation of the present disclosure at different wavelengths.

### DETAILED DESCRIPTION OF THE PREFERRED EMBODIMENTS

The present disclosure will be illustrated in detail below with preferred embodiments and accompanying drawings. It should be noted that, the shape and scale of the diagrams disclosed in each embodiment below are intended to account for the technical features of the present disclosure, and are not intended to limit the aspects of the present disclosure on the practical implementation.

It is to be acknowledged that, although the terms ‘first’, ‘second’, and so on, may be used herein to describe various elements, components, areas, sections, layers and/or parts, these elements, components, areas, sections, layers and/or parts should not be limited by these terms. These terms are used only for the purpose of distinguishing one element, component, area, section, layer and/or part from another element, component, area, section, layer and/or part.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and the present specification, and should not be interpreted in an idealized or overly formal sense, unless expressly so defined herein.

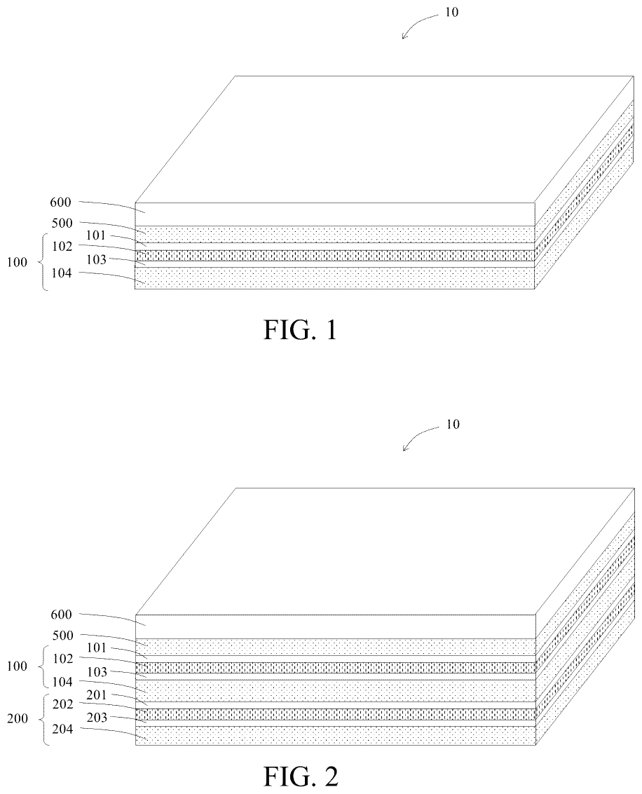

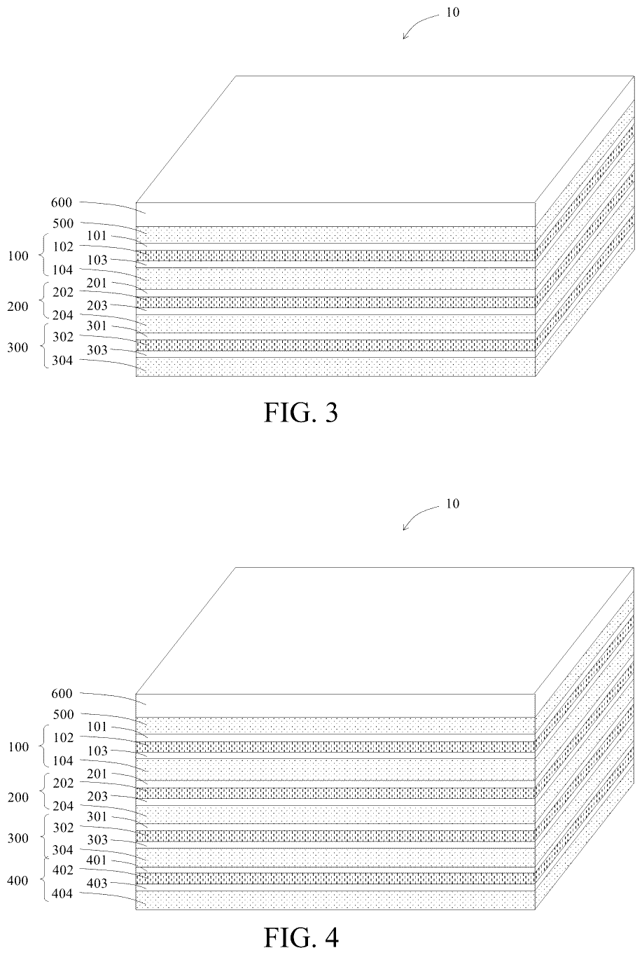

Reference is made to FIGS. 1 to 4, FIG. 1 is a schematic diagram of an anti-reflection coating for blocking infrared radiation according to a first embodiment of the present disclosure, FIG. 2 is a schematic diagram of an anti-reflection coating for blocking infrared radiation according to a second embodiment of the present disclosure, FIG. 3 is a schematic diagram of an anti-reflection coating for blocking infrared radiation according to a third embodiment of the present disclosure, and FIG. 4 is a schematic diagram of an anti-reflection coating for blocking infrared rays according to a fourth embodiment of the present disclosure.

An anti-reflection coating 10 for blocking infrared radiation of the present disclosure includes anti-reflection composite layers 100, 200, 300, 400, an oxidation protective layer 500 and a visible light anti-reflection layer 600. The oxidation protection layer 500 is disposed on the anti-reflection composite layers 100, 200, 300, 400, and the visible light anti-reflection layer 600 is disposed on the oxidation protective layer 500.

At least one of the anti-reflection composite layers 100, 200, 300, 400 can be disposed. As shown in FIG. 1, in the first embodiment, the anti-reflection coating has only one anti-reflection composite layer 100. As shown in FIG. 2, in the second embodiment, the anti-reflection coating has the first anti-reflection composite layer 100 and the second anti-reflection composite layer 200. As shown in FIG. 3, in the third embodiment, the anti-reflection coating has the first anti-reflection composite layer 100, the second anti-reflection composite layer 200 and the third anti-reflection composite layer 300. In the fourth embodiment, the anti-reflection coating has the first anti-reflection composite layer 100, the second anti-reflection composite layer 200, the third anti-reflection composite layer 300 and the fourth anti-reflection composite layer 400.

The anti-reflection composite layers 100, 200, 300, 400 respectively include stacked layer formed from top to bottom:first aluminum-doped zinc oxide (Al-doped ZnO, also referred to as AZO) layers 101, 201, 301, 401, metal layers 102, 202, 302, 402, second aluminum-doped zinc oxide layers 103, 203, 303, 403 and niobium pentoxide layers 104, 204, 304, 404.

The first aluminum-doped zinc oxide layer 101, 201, 301, 401 and the second aluminum-doped zinc oxide layer 103, 203, 303, 403 are made of aluminum zinc oxide (AZO) (including zinc oxide (ZnO) as a main component and Al or Al₂O₃ as a trace element). A ratio of ZnO to Al₂O₃ ranges from about 90 to 99.9:0.1 to 10, but the present disclosure is not limited thereto. ‘The composition of the first aluminum-doped zinc oxide layers 101, 201, 301, 401 can be the same as or different from the composition of the second aluminum-doped zinc oxide layers 103, 203, 303 and 403. In addition, the composition of the first aluminum-doped zinc oxide layers 101, 201, 301, 401 and the second Al-doped ZnO layer 103, 203, 303, 403 among the first anti-reflection composite layer 100, the second anti-reflection composite layer 200, the third anti-reflection composite layer 300 and the fourth anti-reflection composite layer 400 can be the same or different from one another.

The metal layers 102, 202, 302, 402 are respectively formed on the second aluminum-doped zinc oxide layers 103, 203, 303, 403, and the metal layers 103, 203, 303, 403 are each comprised of silver or a silver alloy containing about 90 wt. % of Ag. Silver has high flexibility and electric conductivity, and maintains its electric conductivity during a thin film forming process. Silver has further advantages in that it is relatively less expensive than other metals and has low absorptivity of visible light. The composition of the metal layers 102, 202, 302, 402 among the first anti-reflection composite layer 100, the second anti-refraction composite layer 200, the third anti-refraction composite layer 300 and the fourth anti-refraction composite layer 400 can be the same or different from one other.

The niobium pentoxide layers 104, 204, 304, 404 are deposited by a plasma emission monitor (PEM) controlled reactive sputtering using a Niobium(Nb) target in an atmosphere including argon, and oxygen with flow rates of, e.g., about 80 to 450 sccm and 120 sccm respectively. The niobium pentoxide layers 104, 204, 304, 404 can only contain niobium pentoxide (Nb₂O₅), or niobium pentoxide (Nb₂O₅) together with a trace element, and the trace element can be Ti, Cr, Zr, Bi, Al or B. The composition of the niobium pentoxide layers 104, 204, 304, 404 among the first anti-refraction composite layer 100, the second anti-refraction composite layer 200, the third anti-refraction composite layer 300 and the fourth anti-refraction composite layer 400 can be the same as or different from one another.

The oxidation protective layer 500 plays an essential role to enhance film strength. The oxidation protective layer 500 is comprised of niobium pentoxide or niobium pentoxide (Nb₂O₅) together with a trace element. The trace element can be Ti, Cr, Zr, Bi, Al or B, the oxide protection layer 500 can be made in the same process as the niobium pentoxide layers 104, 204, 304, 404 but with different thickness, so as to protect the anti-reflection composite layers 100, 200, 300, 400 while reducing the impact on the overall optical performance.

The visible light anti-reflection layers 600 is comprised of silicon dioxide, which is deposited on the oxidation protective layer 500 by using a silicon target in an atmosphere including Argon and oxygen with flow rates of about 150 to 400 sccm and 120 sccm respectively.

Parameters of each element layer of the anti-reflection coating 10 for blocking infrared radiation provided by the present disclosure are as shown in table 1:

TABLE 1

| Anti- | | | | | Optical Thickness | Physical |
|---|---|---|---|---|---|---|
| Reflection | | Anti-Refractive | Refractive | Extinction | (Full Wave Optical | Thickness |
| Coating | Element Layer | Composite Layer | Index | Coefficient | Thickness, FWOT) | (nm) |
| Medium | Air | — | 1.00000 | 0.00000 | — | — |
| 1 | Visible Light | — | 1.46180 | 0.00000 | 0.10031976~0.15764534 | 35.00~55.00 |
| | Anti-Reflection | | | | | |
| | Layer | | | | | |
| 2 | Oxidation | Niobium Pentoxide Layer | 2.35168 | 0.00000 | 0.09222274 ± 3% | 20.00 ± 3% |
| | Protective Layer | | | | | |
| 3 | First | First Aluminum-doped | 1.92171 | 0.00106 | 0.01884034 ± 3% | 5.00 ± 3% |
| | Anti-Refractive | Zinc Oxide Layer | | | | |
| 4 | Composite Layer | Metal Layer | 0.05100 | 2.96000 | 0.00110000 ± 3% | 11.00 ± 3% |
| 5 | | Second Aluminum-doped | 1.92171 | 0.00106 | 0.01884034 ± 3% | 5.00 ± 3% |
| | | Zinc Oxide Layer | | | | |
| 6 | | Niobium Pentoxide Layer | 2.35168 | 0.00000 | 0.26744596 ± 3% | 58.00 ± 3% |
| 7 | Second | First Aluminum-doped | 1.92171 | 0.00106 | 0.01884034 ± 3% | 5.00 ± 3% |
| | Anti-Refractive | Zinc Oxide Layer | | | | |
| 8 | Composite Layer | Metal Layer | 0.05100 | 2.96000 | 0.00110000 ± 3% | 11.00 ± 3% |
| 9 | | Second Aluminum-doped | 1.92171 | 0.00106 | 0.01884034 ± 3% | 5.00 ± 3% |
| | | Zinc Oxide Layer | | | | |
| 10 | | Niobium Pentoxide Layer | 2.35168 | 0.00000 | 0.26744596 ± 3% | 58.00 ± 3% |
| 11 | Third | First Aluminum-doped | 1.92171 | 0.00106 | 0.01884034 ± 3% | 5.00 ± 3% |
| | Anti-Refractive | Zinc Oxide Layer | | | | |
| 12 | Composite Layer | Metal Layer | 0.05100 | 2.96000 | 0.00110000 ± 3% | 11.00 ± 3% |
| 13 | | Second Aluminum-doped | 1.92171 | 0.00106 | 0.01884034 ± 3% | 5.00 ± 3% |
| | | Zinc Oxide Layer | | | | |
| 14 | | Niobium Pentoxide Layer | 2.35168 | 0.00000 | 0.26744596 ± 3% | 58.00 ± |
| | | | | | | 3% ± 3% |
| 15 | Fourth | First Aluminum-doped | 1.92171 | 0.00106 | 0.01884034 ± 3% | 5.00 ± 3% |
| | Anti-Reflection | Zinc Oxide Layer | | | | |
| 16 | Composite Layer | Metal Layer | 0.05100 | 2.96000 | 0.00110000 ± 3% | 11.00 ± 3% |
| 17 | | Second Aluminum-doped | 1.92171 | 0.00106 | 0.01884034 ± 3% | 5.00 ± 3% |
| | | Zinc Oxide Layer | | | | |
| 18 | | Niobium Pentoxide Layer | 2.35168 | 0.00000 | 0.14294525 ± 3% | 31.00 ± 3% |
| Substrate | Substrate | — | 1.52083 | 0.00000 | — | — |

The above parameters and thicknesses in Table 1 all have a range of ±3%. For example, the physical thickness of the visible light anti-reflection layer 600 is 45.00 nm, that is, the physical thickness of the visible light anti-reflection layer 600 ranges from 43.65 to 46.35 nm, and so forth. Repeated descriptions will be omitted here for the sake of conciseness of the specification.

Therefore, a multilayer structure of the anti-reflective coating shown in FIGS. 1 to 4 is formed through the aforementioned process steps, and the thickness of each layer is optimized to provide specific optical reflection and refraction.

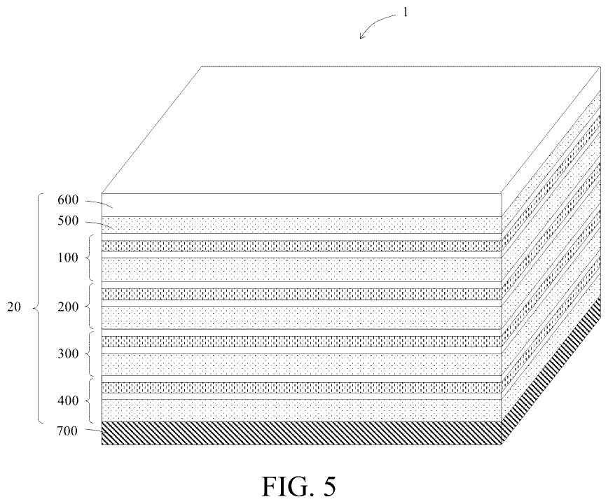

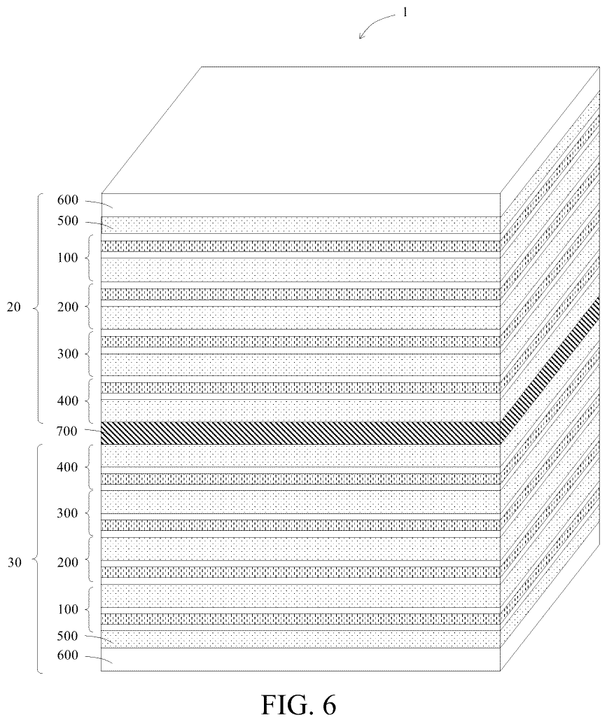

Reference is made to FIGS. 5 and 6, FIG. 5 is a schematic diagram of a display device applying the anti-reflection coatings of FIGS. 1 to 4 according to a fifth embodiment of the present disclosure, and FIG. 6 is a schematic diagram of a display device applying the anti-reflection coatings of FIGS. 1 to 4 according to a sixth embodiment of the present disclosure.

The present disclosure further provides a display device 1. In the fifth embodiment, the display device 1 includes a substrate 700 and a first anti-reflection coating 20, and the first anti-reflection coating 20 is the anti-reflection coating 10 as described above, and disposed on a surface of the substrate 700.

In addition, in the sixth embodiment, the display device 1 includes: a substrate 700, a first anti-reflection coating 20 and a second anti-reflection coating 30, the first anti-reflection coating 20 and the second anti-reflection coating 30 are the anti-reflection coating 10 described above, the first anti-reflection coating 20 is disposed on a surface of the substrate 700, and the second anti-reflection coating 30 is disposed on another surface of the substrate 700.

In one embodiment of the present disclosure, the substrate 700 is glass, and the present disclosure is not limited thereto. A material of the substrate 700 can be glass or a flexible substrate, and the substrate 700 can be surface-processed, for example, the surface of the substrate 700 is polished, such that the substrate 700 has an RMS (root mean square value) roughness of 1 to 10 angstrom (A), and has a peak-to-valley surface roughness of 20 to 150 angstroms. The flexible substrate can include, but are not limited to, polyethylene terephthalate (PET), acrylic resin and other polymers.

For concise description, the anti-reflection coating 10 of the fourth embodiment in FIG. 4 is used in FIGS. 5 and 6 as examples, and the present disclosure is not limited thereto. The second anti-reflection coating 30 can be the same or different structures, and the first anti-reflection coating 20 and the second anti-reflection coating 30 can each be any one of the anti-reflection coatings 10 for blocking infrared radiation of the first embodiment, the second embodiment, the third embodiment, and the fourth embodiment shown in FIGS. 1 to 4, respectively.

Other components of the display device 1 of the present disclosure can be selected as the same components as known display devices according to requirements, for example: the liquid crystal display (LCD) device, the field emission display (FED) device, the plasma display panel (PDP) and the organic light emitting diode (OLED) display device, those skilled in the art can select corresponding components according to the known display devices, and the present disclosure is not limited thereto.

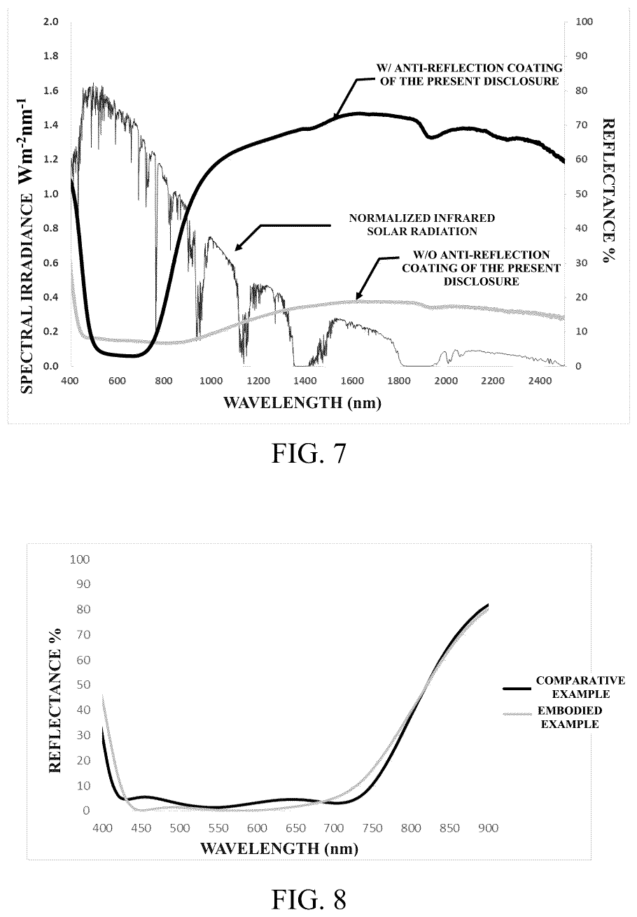

Reference is made to FIG. 7, which is a graph showing a comparison made between reflectance of the anti-reflection coating for blocking infrared radiation of the present disclosure at different wavelengths, in which a curve of normalized infrared solar radiation shows a reflectance of a conventional display device without the anti-reflective coating provided by the present disclosure for each wavelength when sunlight is irradiated, and a curve of the anti-reflection coating of the present disclosure shows a reflectance at each wavelength of the display device 1 that is provided with the anti-reflection coating 10 of the present disclosure when sunlight is irradiated.

Spectrum (300 ˜2500 nm) reflectance and transmittance measurement methods are illustrated as follows:

Lights with wavelengths ranging from 300 to 2500 nm are emitted by a Hitachi spectrometer U-4100 to measure the reflectance and transmittance of the anti-reflection coating 10 manufactured according to the third embodiment of the present disclosure within a wavelength range of 300 to 2500 nm, and the reflectance and transmittance are obtained by measuring a transmitted radiation flux (reflected radiation flux) with a relative radiant efficiency adapted to a CIE chromaticity of a CIE standard light source D₆₅.

$$τ e = {\sum }_{300}^{2100} E λ \cdot Δ λ \cdot τ ( λ ) ; \qquad [ Mathematical formula 1 ]$$

$$ρ e = {\sum }_{300}^{2100} E λ \cdot Δ λ \cdot ρ ( λ ) ; \qquad [ Mathematical formula 2 ]$$

where τe is a sunlight transmittance, ρe is a sunlight reflectance, τ(λ) is a spectral transmittance (measured value), ρ(λ) is a spectral reflectance (measured value), Eλ is a standard spectral distribution of a direct irradiance relative to radiation values of sunlight, and reference can be made to a built-in software and an operation manual of Hitachi spectrometer U-4100.

As shown in FIG. 7, a curve of a normalized infrared solar radiation represents a spectrum of sunlight used in the present embodiment. It can be seen that the conventional display device without the anti-reflection coating of the present disclosure exhibits the reflectance of more than 6% within the wavelength range of visible light (370-780 nm), which causes the conventional display device to glare and is difficult to see in sunlight. In addition, an average reflectance within the infrared wavelength range (780-2500 nm) is lower than 20%, causing high-energy electromagnetic waves such as infrared radiation to penetrate into the traditional display device and deal damages to the internal components. On the contrary, the display device 1 provided with the anti-reflection coating 10 of the present disclosure exhibits the reflectance of 2% within the wavelength range of visible light (370-780 nm), which enhances a luminous efficiency of the display device, increases an intensity of visible light emitted by the display screen, improves a color rendering index (CRI), reduces the brightness required under strong light (such as sunlight), and reduces power consumption and the heat generated. In addition, in the infrared wavelength range (780-2500 nm), an average reflectance is about 65%, which blocks infrared radiation from reaching the inside of the display screen, reflects 32 to 48% of the heat radiation from sunlight to prevent the internal components from being damaged by infrared radiation and reduces the heat absorption caused by sunlight, thereby increasing the service life and reducing the use cost.

Reference is made to FIG. 8, which is a graph showing a comparison made between reflectance of the anti-reflection coating for blocking infrared radiation of the present disclosure at different wavelengths. In FIG. 8, a comparative example is an anti-reflection coating without the visible light anti-reflection layer of the present disclosure, and an embodied example is an anti-reflection coating provided with a visible light anti-reflection layer of the present disclosure.

As shown in FIG. 8, experimental results are shown in Table 2. Compared with the comparative example of the anti-reflection coating 10 without the visible light anti-reflection layer 600 of the present disclosure, the reflectance of the embodied example of the anti-reflection coating 10 provided with the visible light anti-reflection layer 600 of the present disclosure within the wavelength range of visible light (370-780 nm) is significantly reduced from 2.49% to 0.38%, which enhances an luminous efficiency and CRI of the display device 1, to further reduce power consumption and the heat generated.

TABLE 2

| | | | Sunlight | Reflectance |
|---|---|---|---|---|
| | Transmittance of | Reflectance of | (Visible + Infrared) | of Sunlight |
| | Visible Light | Visible Light | Transmittance | (Visible + Infrared) |
| | (370~780 nm) | (370~780 nm) | (300~2500 nm) | (300~2500 nm) |
| Comparative | 91.80% | 2.49% | 37% | 53% |
| Example | | | | |
| Embodied | 93.79% | 0.38% | 36% | 54% |
| Example | | | | |

In summary, in the anti-reflection coating for blocking infrared radiation provided by the present disclosure, the oxidation protective layer, the anti-refractive composite layer and the visible light anti-reflection layer are laminated with specific refractive indices and thicknesses to achieve a required optical refraction, in which a transmittance increases and a reflectance decreases in a wavelength range of visible light, while a transmittance decreases and a reflectance increases in a wavelength range of infrared light. Furthermore, in the anti-reflection coating for blocking infrared radiation provided by the present disclosure, an intensity of visible light emitted by the display screen and color rendering index (CRI) are increased, thereby reducing the brightness required under strong sunlight, the power consumption and the heat generated. Moreover, the anti-reflection coating for blocking infrared radiation provided by the present disclosure blocks the infrared radiations from penetrating into the display screen and reflects 32-48% of heat radiation from sunlight, thereby avoiding internal components being damaged by infrared radiations, reducing the heat absorption caused by sunlight, increasing the service life and reducing the use cost.

The present disclosure has been described above with preferred embodiments, but the description of preferred embodiments is not intended to limit the scope of the present disclosure. Many modifications and variations will be apparent to those having ordinary skill in the art without departing from the spirit and scope of the present disclosure. Therefore, the scope of the present disclosure should be defined by the appended claims.

What is claimed is:

1. An anti-reflection coating for blocking infrared radiation, the anti-reflection coating comprising:
an anti-refractive composite layer;
an oxidation protective layer disposed on the anti-refractive composite layer; and
a visible light anti-reflection layer disposed on the oxidation protection layer;
wherein the anti-reflection coating has a reflectance ranging from 0% to 1% in a wavelength range of 370 to 780 nm, and has a reflectance of 3% to 80% in a wavelength range of 780 to 2500 nm.

2. The anti-reflection coating according to claim 1, wherein the anti-reflection coating has a transmittance ranging from 90% to 100% in the wavelength range of 370 to 780 nm.

3. The anti-reflection coating according to claim 1, wherein the anti-reflection coating has a reflectance ranging from 3% to 80% and a transmittance ranging from 0% to 60% in a wavelength range of 780 nm to 2500 nm.

4. The anti-reflection coating according to claim 1, wherein the visible light anti-reflection layer includes silicon dioxide.

5. The anti-reflection coating according to claim 1, wherein the anti-reflection composite layer includes a first anti-reflection composite layer and/or at least one second anti-reflection composite layer, and the at least one second anti-reflection composite layer is disposed on a surface of the first anti-reflection composite layer.

6. The anti-reflection coating according to claim 5, wherein a thickness ratio of the oxidation protective layer, the anti-reflection composite layer and the visible light anti-reflection layer is 30.07 to 31.93:T: 43.65 to 46.35, where T=A+n×B, A is a thickness of the first anti-reflection composite layer, B is a thickness of the second anti-reflection composite layer, and n is an integer.

7. The anti-reflection coating according to claim 5, wherein the first anti-reflection composite layer includes, sequentially from top to bottom, a first aluminum-doped zinc oxide layer, a metal layer, a second aluminum-doped zinc oxide layer and a niobium pentoxide layer in a thickness ratio of 4.85 to 5.15:10.67 to 11.33:4.85 to 5.15:19.4 to 20.6.

8. The anti-reflection coating according to claim 5, wherein each of the at least one second anti-reflection composite layer includes, sequentially from top to bottom, a first aluminum-doped zinc oxide layer, a metal layer, a second aluminum-doped zinc oxide layer zinc layer and a niobium pentoxide layer in a thickness ratio is 4.85 to 5.15:10.67 to 11.33:4.85 to 5.15:56.26 to 59.74.

9. A display device, comprising:
a substrate; and
a first anti-reflection coating being the anti-reflection coating according to claim 1,
wherein the first anti-reflection coating is disposed on a surface of the substrate.

10. The display device according to claim 9, further comprising: a second anti-reflection coating being the anti-reflection coating, wherein the second anti-reflection coating is disposed on another surface of the substrate.
